(19) United States
(12) Patent Application Publication
(10) Pub. No.: US 2007/0091372 A1
(43) Pub. Date: Apr. 26, 2007

(54) Image forming device and print control program

(76) Inventor: Yoshitaka Matsuki, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,158

(22) Filed: Oct. 26, 2005

(51) Int. Cl. G06K 15/00

(52) U.S. Cl. 358/1.18; 358/527

(57) ABSTRACT

An image forming device having a Nup printing function for reducing and printing a plurality of images on a single sheet, comprising: display means for displaying a layout preview for each sheet in the case of Nup printing; and input means for increasing/decreasing the number of images to be printed on a single sheet, for each sheet displayed on the display means, and modifying the print layout.

### FIELD OF THE INVENTION

The present invention relates to an image forming device for printing a plurality of pages of images on a single sheet, and to a storage medium for a print control program.

### BACKGROUND INFORMATION

A multi-function machine, having a plurality of functions such as copying, FAX transmission and reception, printing, and the like, has a Nup printing function for printing a plurality of pages of images on a single sheet. Nup printing is the printing of N document pages on a single sheet. For example, in the case of two pages of A4 size document data, each page of document data is reduced to A5 size and two pages of document data are printed on a single sheet of A4 paper. In Nup printing, printing two pages on a single sheet is called 2up printing, and printing four pages on a single sheet is called 4up printing.

The prior art includes systems for printing a cover sheet without Nup and then Nup printing for the second page and beyond, for Nup printing of mixed documents, and for Nup printing starting from a specified page.

However, these devices have the following problems relating to Nup printing: much work is required to configure and print an arbitrary layout, and much work may result from printing having to be divided into a plurality of instances to print a desired layout.

The present invention was developed in consideration of such facts; and an object of the present invention is to provide an image forming device, with which an arbitrary layout can be easily configured when printing a plurality of pages of images on a single sheet, and to a storage medium for a print control program.

### SUMMARY OF THE INVENTION

In the invention recited in claim 1, an image forming device having a Nup printing function for reducing and printing a plurality of images on a single sheet, comprises display means for displaying a layout preview for each sheet in the case of Nup printing; and input means for increasing/decreasing the number of images to be printed on a single sheet, for each sheet displayed by the display means, and modifying the print layout.

In the invention recited in claim 2, an image forming device having a Nup printing function for reducing and printing a plurality of images on a single sheet, comprises display means for displaying a layout preview for each sheet in the case of Nup printing; and input means for configuring a logical page for each sheet displayed by the display means, while further dividing or canceling divisions within a configured logical page and positioning a plurality of logical pages on a single sheet, correlating image data to be printed with the logical pages, and modifying the print layout.

In the invention recited in claim 3, the input means provides an upper limit to the number of images printed on a single sheet, based on attributes of image data to be printed on a sheet.

In the invention recited in claim 4, images to be printed are displayed on each page of the layout preview.

The invention recited in claim 5 is a storage medium storing a print control program for controlling an image forming device having a Nup printing function for reducing and printing a plurality of images on a single sheet; wherein the print control program causes the image forming device to execute: a display process for displaying a layout preview of each sheet in the case of Nup printing; and an input process for increasing/decreasing the number of images to be printed on a single sheet, for each sheet displayed by the display process, and modifying the print layout.

The invention recited in claim 6 is a storage medium storing a print control program for controlling an image forming device having a Nup printing function for reducing and printing a plurality of images on a single sheet; wherein are executed a display process for displaying a layout preview for each sheet in the case of Nup printing; and an input process for configuring a logical page for each sheet displayed by the display process, while further dividing or canceling divisions within a configured logical page and positioning a plurality of logical pages on a single sheet, correlating image data to be printed with the logical pages, and modifying the print layout.

In the invention recited in claim 7, the input process provides an upper limit to the number of images printed on a single sheet, based on attributes of image data to be printed on a sheet.

In the invention recited in claim 8, images to be printed are displayed on each page of the layout preview.

The present invention has the effect of allowing any layout to be configured and printed easily because a layout preview screen is displayed and because the Nup printing configuration can be performed in a simple manner for each page displayed, in Nup printing for printing a plurality of pages of images on a single sheet. Also, because of the provision of an upper limit to the images printed on a single sheet, it is possible to prevent printed text and the like from becoming illegible. Also, because the preview screen displays the image to be printed, a user can configure Nup printing easily while watching the screen.

### BRIEF DESCRIPTION OF THE DRAWINGS

FIG. 1 is a block diagram showing the constitution of a first embodiment of the present invention.

FIG. 2 is a schematic view showing an example of a screen display when specifying Nup printing.

FIG. 3 is a schematic view showing an example of a screen display when specifying Nup printing.

FIG. 4A through FIG. 4D are schematic views showing layout configuration changes.

FIG. 5 is a schematic view showing results of modifying the layout.

FIG. 6 is a schematic view showing an example of a screen display when specifying Nup printing.

FIG. 7A through FIG. 7D are schematic views showing layout configuration changes.

FIG. 8 is a schematic view showing results of modifying the layout.

### DETAILED DESCRIPTION OF THE PREFERRED EMBODIMENTS

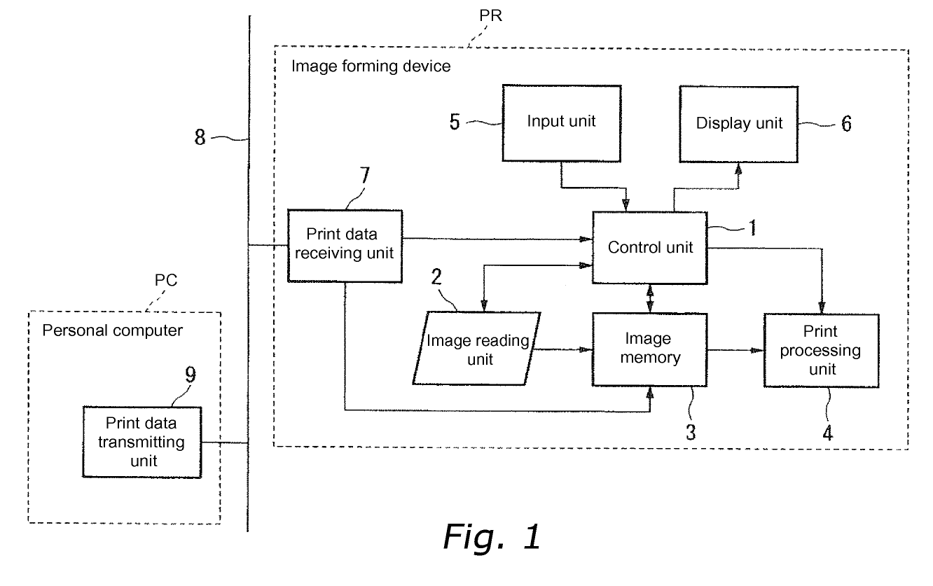

An image forming device according to an embodiment of the present invention is described below with reference to the drawings. FIG. 1 is a block diagram showing the constitution of this embodiment. In this drawing, the reference PR indicates an image forming device, which is a multi-function machine comprising functions such as copying, FAX transmission and reception, printing, and the like. The reference 1 indicates a control unit for administering the operations of the image forming device PR. The reference 2 indicates an image reading unit for reading images in color or black and white and converting the images to digital image data. The reference 3 indicates image memory for storing image data read by the image reading unit 2 or print data transmitted from the personal computer PC. The reference 4 indicates a print processing unit for printing data stored in the image memory 3, and controls the operations of feeding, printing, and delivery. The reference 5 indicates an input unit consisting of a numeric key pad, function keys, touch panel, and the like. The reference 6 indicates a display unit consisting of a liquid crystal display. The reference 7 indicates a print data receiving unit for receiving print data transmitted from the personal computer PC. The reference 8 indicates a computer network whereon the image forming device PR and personal computer PC are connected and transmit information to each other. The reference 9 indicates a print data transmitting unit provided within the personal computer PC, which generates print data for performing operations control for printing an image prepared with application software on the personal computer PC on the image forming device PR, and which transmits the data from the personal computer PC to the image forming device PR.

Next, the operation of the device shown in FIG. 1 is described. The example described here is of the operation for printing, on the image forming device, text data prepared using an application (word processing software, for example) on the personal computer PC. The user uses an application on the personal computer PC and prepares text data. The preparation of twenty A4-sized pages of text data is described here.

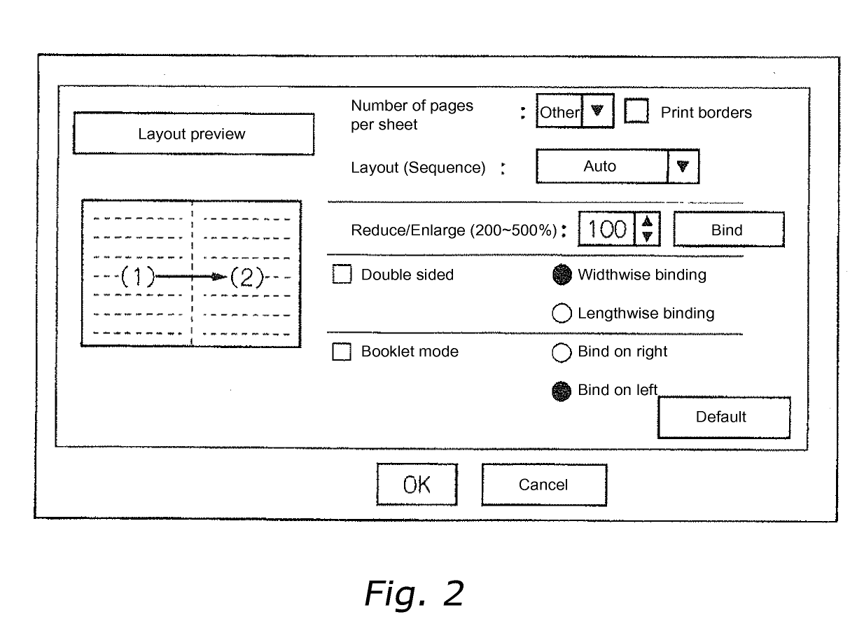

Next, the user operates the personal computer PC and specifies “A4” as the paper size to use, while specifying “Nup printing”, whereupon the application on the personal computer PC outputs the print instruction for Nup printing to the print data transmitting unit 9. Upon receiving this instruction, the print data transmitting unit 9 displays the Nup printing configuration screen on the screen of the personal computer PC. FIG. 2 shows an example of the Nup printing configuration screen. The user selects “2, 4, 8, . . . , Other” as “Pages per sheet.” Here, “Other” is selected as the number of pages per sheet.

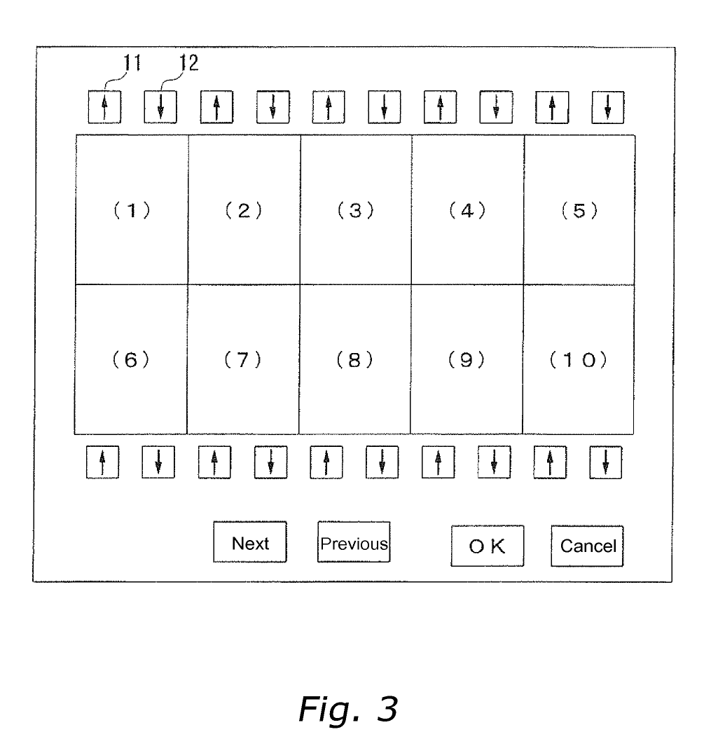

Next, the user clicks the “Layout preview” button on the Nup printing configuration screen. Upon receiving this command, the print data transmitting unit 9 displays the layout preview screen on the personal computer PC. FIG. 3 shows an example of the layout preview screen. As shown in FIG. 3, the layout of each page is displayed on the layout preview screen. In FIG. 3, (1) to (10) show the printing of pages 1 to 10 of the text data on the first through tenth sheets of paper; the initial configuration of pages 1 to 10 (unreduced configuration) is displayed because “Other” was selected as the number of pages per sheet in this example. When the “Next” button is clicked, the initial configuration of pages 11 to 20 is displayed; at this time, when the “Previous” button is clicked, the initial configuration of pages 1 to 10 is displayed. The “Next” button displays the configuration of pages following those pages currently displayed; the “Previous” button displays the configuration of pages previous to those pages currently displayed. The increase pages buttons “↑” 11 and decrease pages buttons “↓” 12 are positioned above the first through fifth sheets and below the sixth through tenth sheets. The increase pages buttons 11 are buttons for increasing the number of images positioned on the subject sheet; the decrease pages buttons 12 are buttons for decreasing the number of images positioned on the subject sheet.

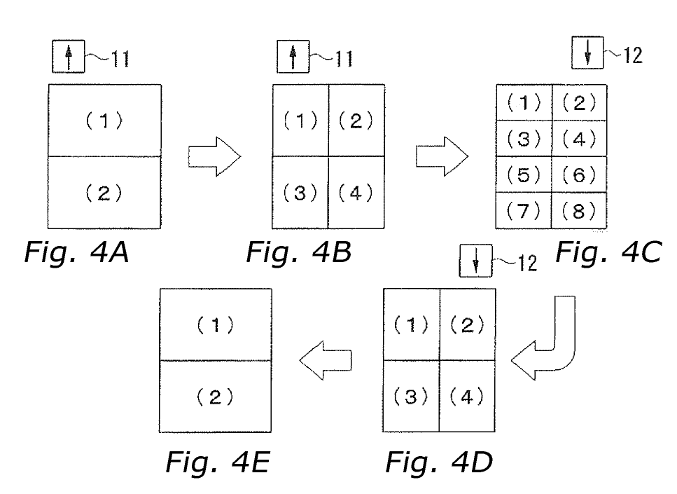

Next, the user views this screen and clicks the OK button to print this layout; or, if there are pages for which the user wants to configure Nup printing, the user clicks the “Increase pages” button for the sheets for which the user wants to configure Nup printing. When the “Increase pages” button is clicked, the print data transmitting unit 9 performs the layout modification processing for Nup printing. The configuration transitions in the layout modification processing performed by the print data transmitting unit 9 are described with reference to FIG. 3 and FIG. 4A to FIG. 4D. Described here are the configuration transitions for when the increase pages button “↑” 11 and the decrease pages button “↓” 12 for the first sheet are clicked. FIG. 4A through FIG. 4D show the configuration transitions on the preview screen. When the increase pages button 11 for the first sheet in FIG. 3 is clicked, the first sheet is divided in half; as shown in FIG. 4A, the images of page (1) and page (2) are positioned on the first sheet. When the increase pages button 11 for the first sheet is clicked again, these are divided in halves again and the images of pages (1) through (4) are positioned on the first sheet (see FIG. 4B). When in this state the increase pages button 11 for the first sheet is clicked again, these are divided in halves again and the images of pages (1) through (8) are positioned on the first sheet (see FIG. 4C).

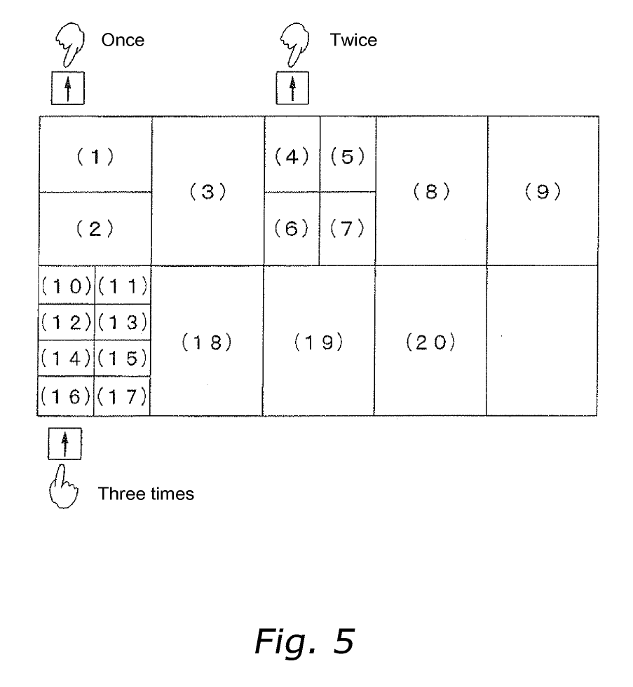

Meanwhile, when the decrease pages button 12 for the first sheet is clicked from the configuration in FIG. 4C, the divisions in half are cancelled and the configuration returns to the configuration where images of pages (1) to (4) are positioned on the first sheet (see FIG. 4D). When the decrease pages button 12 for the first sheet is clicked again, the divisions in half are cancelled and the configuration returns to the configuration where images of pages (1) and (3) are positioned on the first sheet (see FIG. 4E). These division/cancellation configurations are displayed on the preview screen; the user operates the input unit 5 and configures the print layout while viewing this screen. FIG. 5 shows an example of layout configuration. In this example, the increase pages button for the first sheet is clicked one time, the increase pages button for the third sheet is clicked twice, and the increase pages button for the sixth sheet is clicked three times. Because there are twenty pages of data to be printed, the data are printed on nine sheets and there is no printing on the tenth sheet in this configuration example.

In this way, each page is divided in half when the increase pages button for each sheet is clicked; the division in half for each page is cancelled and the configuration returns to the previous configuration when the page cancellation button is clicked. While viewing the layout preview screen, the user operates the increase pages button 11 and the decrease pages button 12, and clicks the OK button when the desired layout is achieved. When the OK button in the layout preview screen is clicked, the print data transmitting unit 9 again displays the Nup printing configuration screen (FIG. 2) on the personal computer. If there is no problem with the configured contents, the user clicks the OK button on the Nup printing configuration screen. At this point, the numbers of the pages to be printed on each sheet are stored in the print data transmitting unit 9.

Next, the print data transmitting unit 9 sends an output command for the text data to the application that sent the print instruction. In response, the application divides the text data into pages and sequentially outputs the pages to the print data transmitting unit 9. This text data includes information such as the paper size to be used and the page size used in the text data. Upon receiving this data, the print data transmitting unit 9 prepares the print data for each sheet used for printing from the text data for each page and the page numbers to be printed on each sheet. The print data transmitting unit 9 then sequentially outputs the print data attained for each sheet and the paper size to be used to the image forming device PR.

The print data receiving unit 7 receives this print data over a computer network 8. The print data receiving unit outputs the received information for the paper size to be used to the control unit 1 and stores the print data in the image memory 3. Upon receiving this information, the control unit 1 sends an instruction to the print processing unit 4 to print the print data stored in the image memory 3 on sheets of the size to be used. Upon receiving this instruction, the print processing unit 4 prints the print data stored in the image memory 3. Thereby, Nup printing based on the layout configured on the preview screen is performed.

The operations in the case of using the copy (copy) function of the image forming device alone is described next.

The copying of a document of twenty A4 size pages in the layout configuration shown in FIG. 5 is described here. The user places all twenty pages of the document in order on the image reading unit 20 and effects the reading of the image. Thereby, the image data read for the twenty pages is stored in the image memory 3.

Next, the user specifies Nup printing with the input unit 5, while specifying A4 as the paper size to be used. Upon receiving this, the control unit 1 displays the Nup printing configuration screen (FIG. 2) on the display unit 6.

Next, the user clicks the “Layout preview” button on the Nup printing configuration screen. Thereupon, the control unit 1 displays the layout preview screen (FIG. 3) on the display unit 6. The layout of each page is displayed on the layout preview screen.

Next, the user views this screen and clicks the OK button to print this layout; or, if there are pages for which the user wants to configure Nup printing, the user clicks the increase pages button or the decrease pages button and configures the layout for the pages for which the user wants to configure Nup printing. The configuration transitions at this time are the same operations as discussed above (FIG. 4A to FIG. 4D). Thereupon, the control unit 1 displays the layout preview screen of the laid out pages to be printed on each sheet on the display unit 6.

The user looks at this layout preview screen and touches the OK button to print this layout. When the OK button on the layout preview screen is touched, the control unit 1 again displays the Nup printing configuration screen (FIG. 2) on the display unit 6. If there is no problem with the configured contents, the user touches the OK button on the Nup printing configuration screen. At this time, the numbers of the pages to be printed on each sheet are stored in the control unit 1.

Next, the control unit 1 generates the print data for each sheet used for printing from the image data in the image memory 2 and the page numbers to be printed on each sheet, and again stores the print data in the image memory 2. The control unit 1 then sends an instruction to the print processing unit 4 to print the print data stored in the image memory 3 on sheets of the size to be used. Upon receiving this instruction, the print processing unit 4 prints the print data stored in the image memory 3. Thereby, Nup printing based on the layout configured on the preview screen is performed.

Thus it is easily possible to configure and print any layout because a layout preview screen is displayed and because the Nup printing configuration can be performed simply for each page displayed, in Nup printing for printing a plurality of pages of images on a single sheet.

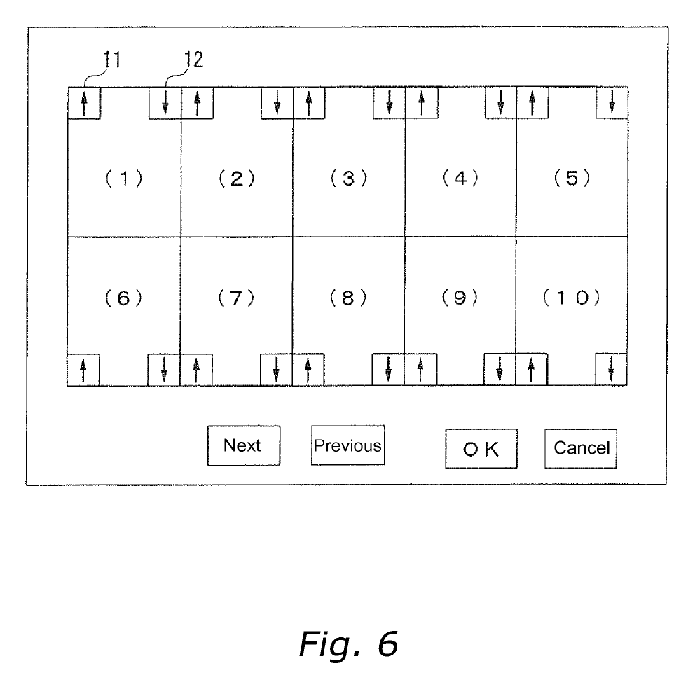

Another embodiment is described next with reference to FIG. 6 through FIG. 8. FIG. 6 shows an example of the preview screen display in another embodiment. The preview screen shown in FIG. 6 differs from the preview screen shown in FIG. 3 with regards to the increase pages button 11 and the decrease pages button 12 being positioned in each page.

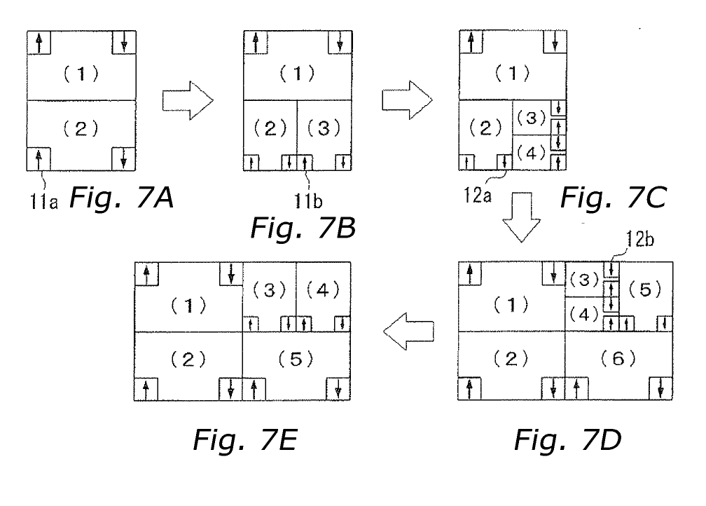

The configuration transitions during layout configuration are described with reference to FIG. 7A through FIG. 7D. When the increase pages button 11 for the first page in FIG. 6 is clicked, the first sheet is divided in half, as shown in FIG. 7A, and the images of page (1) and page (2) are positioned on the first sheet. The page positioned on the first sheet (page (1) and page (2)) is called a logical page; an increase pages button and decrease pages button are positioned on each logical page. The definition of the logical page and the process for positioning the increase pages button and the decrease pages button in each logical page are performed by the print data transmitting unit 9 or the control unit 1.

Next, when the increase pages button 11a of the logical page (2) is clicked, only the logical page (2) is further divided in half, and the images of pages (1) to (3) are positioned on the first sheet (see FIG. 7B). When the increase pages button 11b for the logical page (3) is clicked in this state, the page is further divided in half and the images of pages (1) through (4) are positioned on the first sheet (see FIG. 4C).

On the other hand, when the decrease pages button 12A of the logical page (2) on the first sheet is clicked from the configuration shown in FIG. 7C, the division of the logical page (2) is cancelled, the configuration returns to the configuration before that division (FIG. 7D), and logical pages (3) and (4) are moved to the second sheet without the sizes thereof being changed. Furthermore, the logical pages (5) and (6) are positioned in order on the second sheet. When the decrease pages button 12b on the logical page (3) is clicked from the configuration shown in FIG. 7D, the division of the logical page (3) is cancelled, the configuration returns to the configuration before division (FIG. 7E), and the logical pages (3), (4), and (5) are positioned in order on the second sheet.

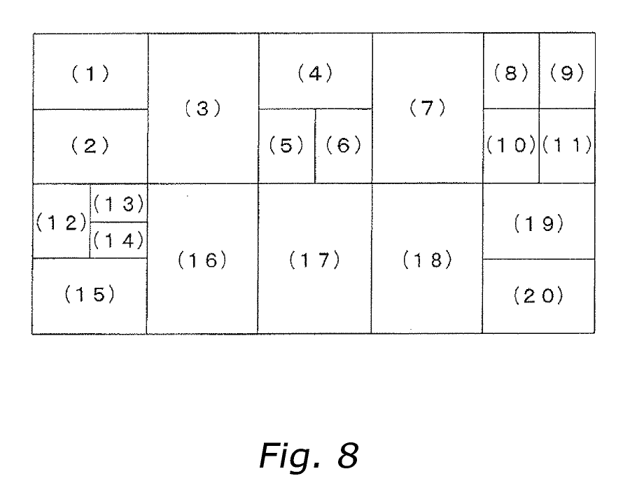

When the increase pages button is clicked, the subject logical page portion is divided in half, two logical pages are positioned, an increase pages button and decrease pages button are positioned in each logical page, and this makes it possible to modify the layout on the basis of individual logical pages. Thereby, the layout configuration shown in FIG. 8 becomes possible. In the layout shown in FIG. 5, the sizes of the pages to be printed on each sheet are the same, however, in the layout shown in FIG. 8, the sizes of the pages to be printed on each sheet can be changed.

Moreover, an upper limit to the number of images printed on a single sheet, meaning a limit to the rate of reduction for the image data, may also be provided based on attributes of the image data to be printed on a sheet. In the case of Nup printing, the image data are reduced and positioned on a sheet, but there is theoretically no limit to the reduction in the case of configuring an arbitrary number of pages per sheet. However, it is sometimes senseless to print material in a configuration such that the print output cannot be read. In order to prevent such a situation from arising, the user is warned when the reduction limit is exceeded, based on the attributes of the image data to be reduced, when image data must be reduced according to the user's configuration. For example, the maximum reduction rate for each character size is stored in advance in the print data transmitting unit 9 or control unit 1; the character data for the smallest size character is extracted from character data included in the image data to be reduced; the maximum reduction rate for that character size is compared with the reduction rate for reduction according to the user's configuration; and a warning is displayed when the reduction rate to be used exceeds the maximum reduction rate. In this way, the printing of material which cannot be read can be prevented.

In the layout preview screen shown in FIG. 3 and FIG. 6, the actual image data may be displayed along with the page number showing each page. Accordingly, Nup printing can be configured and cancelled while viewing the image itself displayed on the preview screen. In cases where there is much data to be printed or the like, the page to be cancelled must be remembered and set in advance; however, because the configuration and cancellation can be specified while viewing the images, it is possible to eliminate mistaken specifications.

A program for implementing the functions of the control unit 1 and print data transmitting unit 9 in FIG. 1 may be stored in a computer-readable storage medium; the print control processing may be performed by the program stored in this storage medium being read in and executed by a computer system. This “computer system” may include an operating system and hardware such as peripheral devices. Also, this “computer-readable storage medium” is a portable medium such as a floppy disk, magneto-optical disk, ROM, CD-ROM, or the like, or a memory device such as a hard disk installed in the computer system. Furthermore, this “computer-readable storage medium” may include that which stores the program for a certain period of time, such as volatile memory (RAM) within a computer system of a server and client in the case where the program is transmitted over a network such as the internet, or telecommunications lines such as telephone lines.

The program may also be transmitted to another computer system via a transmission medium, or by transmission waves in a transmission medium, from the computer system wherein this program is stored in a storage device or the like. Here, the “transmission medium” for transmitting the program is a medium having a function for transmitting information such as a network (telecommunications network) such as the internet, or telecommunications lines (telecommunications lines) such as telephone lines. The program may also have the purpose of implementing some of the functions discussed above. Furthermore, the program may also be what is called a difference file (difference program), which can implement the functions discussed above in combination with a program already stored in the computer system.

What is claimed is:

1. An image forming device having a Nup printing function for reducing and printing a plurality of images on a single sheet, comprising:
display means for displaying a layout preview for each sheet in the case of Nup printing; and
input means for increasing/decreasing the number of images to be printed on a single sheet, for each sheet displayed by the display means, and modifying the print layout.

2. An image forming device having a Nup printing function for reducing and printing a plurality of images on a single sheet, comprising:
display means for displaying a layout preview for each sheet in the case of Nup printing; and
input means for configuring a logical page for each sheet displayed by the display means, while further dividing or canceling the divisions within a configured logical page, placing a plurality of logical pages on a single sheet, correlating image data to be printed with the logical pages, and modifying the print layout.

3. The image forming device recited in claim 1, wherein the input means provide an upper limit to the number of images printed on a single sheet, based on attributes of image data to be printed on a sheet.

4. The image forming device recited in claim 1, wherein images to be printed are displayed on each page of the layout preview.

5. A storage medium for storing a print control program for controlling an image forming device having a Nup printing function for reducing and printing a plurality of images on a single sheet; the print control program causing the image forming device to execute:
a display process for displaying a layout preview for each sheet in the case of Nup printing; and
an input process for increasing/decreasing the number of images to be printed on a single sheet, for each sheet displayed by the display process, and modifying the print layout.

6. A storage medium for storing a print control program for controlling an image forming device having a Nup printing function for reducing and printing a plurality of images on a single sheet; the print control program executing:
a display process for displaying a layout preview for each sheet in the case of Nup printing; and
an input process for configuring a logical page for each sheet displayed by the display process, while further dividing or canceling the divisions within a configured logical page, placing a plurality of logical pages on a single sheet, correlating image data to be printed with the logical pages, and modifying the print layout.

7. The storage medium for a print control program recited in claim 5, wherein the input process provides an upper limit to the number of images printed on a single sheet, based on attributes of image data to be printed on a sheet.

8. The storage medium for a print control program recited in claim 5, wherein images to be printed are displayed on each page of the layout preview.
